(19) United States
(12) Patent Application Publication
(10) Pub. No.: US 2013/0268267 A1
(43) Pub. Date: Oct. 10, 2013

(54) APPARATUS AND METHOD FOR CANCELLING WIDEBAND ACOUSTIC ECHO

(71) Applicant: ELECTRONICS AND TELECOMMUNICATIONS RESEARCH INSTITUTE, Daejeon (KR)

(72) Inventors: In Ki HWANG, Daejeon (KR); Chang CHOO, San Jose, CA (US); Byung Sun LEE, Daejeon (KR)

(73) Assignee: Electronics and Telecommunications Research Institute, Daejeon (KR)

(21) Appl. No.: 13/857,556

(22) Filed: Apr. 5, 2013

(30) Foreign Application Priority Data
Apr. 6, 2012 (KR) 10-2012-0036254

(51) Int. Cl. G10L 21/0208

(52) U.S. Cl. CPC G10L 21/0208
USPC 704/226

(57) ABSTRACT

Disclosed is an apparatus for cancelling a wideband acoustic echo, the apparatus including a determining unit to determine whether a monitor coefficient value obtained by dividing a Near-End Talker (NET) energy value by an ERROR energy value converges to an acoustic echo cancelling reference value.

### CROSS-REFERENCE TO RELATED APPLICATION

This application claims the priority benefit of Korean Patent Application No. 10-2012-0036254, filed on Apr. 6, 2012, in the Korean Intellectual Property Office, the disclosure of which is incorporated herein by reference.

### BACKGROUND

1. Field of the Invention

The present invention relates to an apparatus and method for cancelling a wideband acoustic echo, equipped in an embedded system.

2. Description of the Related Art

An acoustic echo may refer to a voice signal that is output from a terminal speaker, to be input through a microphone in various paths and delivered to a Far-End Talker (FET), and an apparatus for cancelling an acoustic echo is employed to cancel such an echo.

A method for cancelling an acoustic echo may include a variety of methods using a space-time and space-frequency, and such methods have been improved to meet standards of time convergence to lower the acoustic echo below a predetermined level, a processing ability of a long echo path, double-talk detecting time, an amount of calculation, and the like.

A general Normalized Least Mean Square (NLMS) method for cancelling an acoustic echo may calculate energy of a Far-End-Talker (FET) signal, and perform a filtering operation of adding a set of an M number of FET signals as a reference value to be multiplied by a set of an M number of current NLMS coefficient values of a filter.

In general, a result of the filtering operation may be referred to as a similar echo signal, and a resulting value obtained by subtracting the similar echo signal from a Near-End Talker (NET) signal is defined as an ERROR value.

An apparatus for cancelling an acoustic echo may obtain a current coefficient value of a filter when the ERROR value is divided by an FET signal energy value and multiplied by a set of FET signal values to be multiplied by a filter step coefficient value and to be added to a previous NLMS coefficient value of a filter.

However, power consumption of apparatuses for cancelling an acoustic echo may increase during cancellation of such an echo, and the apparatuses for cancelling the acoustic echo may malfunction due to signal noise.

### SUMMARY

According to an aspect of the present invention, there is provided an apparatus for cancelling a wideband acoustic echo, the apparatus including a determining unit to determine whether a monitor coefficient value obtained by dividing a Near-End Talker (NET) energy value by an ERROR energy value converges to an acoustic echo cancelling reference value, an internal memory to store a coefficient value of a filter when the monitor coefficient value converges to the acoustic echo cancelling reference value, a calculating unit to calculate a threshold value of the coefficient value of the filter and a performance index, a register to store data location information when the coefficient value of the filter is less than or equal to the threshold value, an index counter to increase a feedback counter value when the performance index is determined to be lower than a predetermined convergence index based on a result of the comparing the performance index and the predetermined convergence index, using the determining unit, and a restoring unit to restore the feedback counter value to the coefficient value of the filter when the feedback counter value corresponds to a predetermined restoring reference value.

The filter may apply a Normalized Least Mean Square (NLMS) adaptive filter.

When a filtering operation with respect to a subsequent data sample is performed, performing a filtering operation and a coefficient updating with respect to a location stored in the register may be omitted.

The apparatus for cancelling the wideband acoustic echo may further include a detecting unit to detect an occurrence of a double-talk with respect to noise of data.

The detecting unit may include an energy calculating unit to calculate a Far-End Talker (FET) energy value and an NET energy value with respect to the data.

The detecting unit may further include an energy comparing unit to compare the FET energy value and the NET energy value to a noise energy level, a detecting counter to increase a detected counter value when the FET energy value and the NET energy value are determined to be higher than the noise energy level as a result of the comparing, and a determining unit to determine that an occurrence of a double-talk with respect to the noise of data is detected when the detected counter value corresponds to a predetermined double-talk reference value.

According to an aspect of the present invention, there is provided a method for cancelling a wideband acoustic echo, the method including determining whether a monitor coefficient value obtained by dividing a Near-End Talker (NET) energy value by an ERROR energy value converges to an acoustic echo cancelling reference value, storing a coefficient value of a filter in an internal memory when the monitor coefficient value converges to the acoustic echo cancelling reference value, calculating a threshold value of the coefficient value of the filter, storing data location information in a register when the coefficient value of the filter is less than or equal to the threshold value, calculating a performance index, comparing the performance index and a predetermined convergence index, increasing a feedback counter value when the performance index is lower than the predetermined convergence index, and restoring the feedback counter value to a coefficient value of a filter when the feedback counter value corresponds to a predetermined restoring reference value.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of an apparatus for cancelling a wideband acoustic echo according to an embodiment of the present invention;

FIG. 2 is a flowchart illustrating a method for cancelling a wideband acoustic echo according to an embodiment of the present invention; and

FIG. 3 is a flowchart illustrating a method for detecting a double-talk according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

When it is determined that a detailed description related to a related known function or configuration which may make the purpose of the present invention unnecessarily ambiguous in the description of the present invention, such detailed description will be omitted. Also, terminologies used herein are defined to appropriately describe the exemplary embodiments of the present invention and thus may be changed depending on a user, the intent of an operator, or a custom. Accordingly, the terminologies must be defined based on the following overall description of this specification.

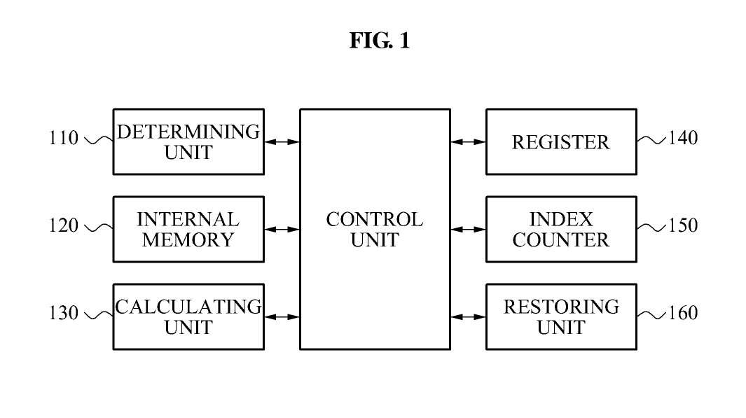

FIG. 1 is a block diagram illustrating a configuration of an apparatus for cancelling a wideband acoustic echo according to an embodiment of the present invention.

The apparatus for cancelling the wideband acoustic echo may include a determining unit 110 to determine whether a monitor coefficient value obtained by dividing a Near-End Talker (NET) energy value by an ERROR energy value converging to an acoustic echo cancelling reference value, an internal memory 120 to store a coefficient value of a filter when the monitor coefficient value converges to the acoustic echo cancelling reference value, a calculating unit 130 to calculate a threshold value of the coefficient value of the filter and a performance index, a register 140 to store data location information when the coefficient value of the filter is less than or equal to the threshold value, an index counter 150 to increase a feedback counter value when the performance index is determined to be lower than a predetermined convergence index based on a result of the comparing the performance index and the predetermined convergence index, using the determining unit 110, and a restoring unit 160 to restore the feedback counter value to a coefficient value of a filter when the feedback counter value corresponds to a predetermined restoring reference value.

According to an embodiment of the present invention, the filter may apply a Normalized Least Mean Square (NLMS) adaptive filter.

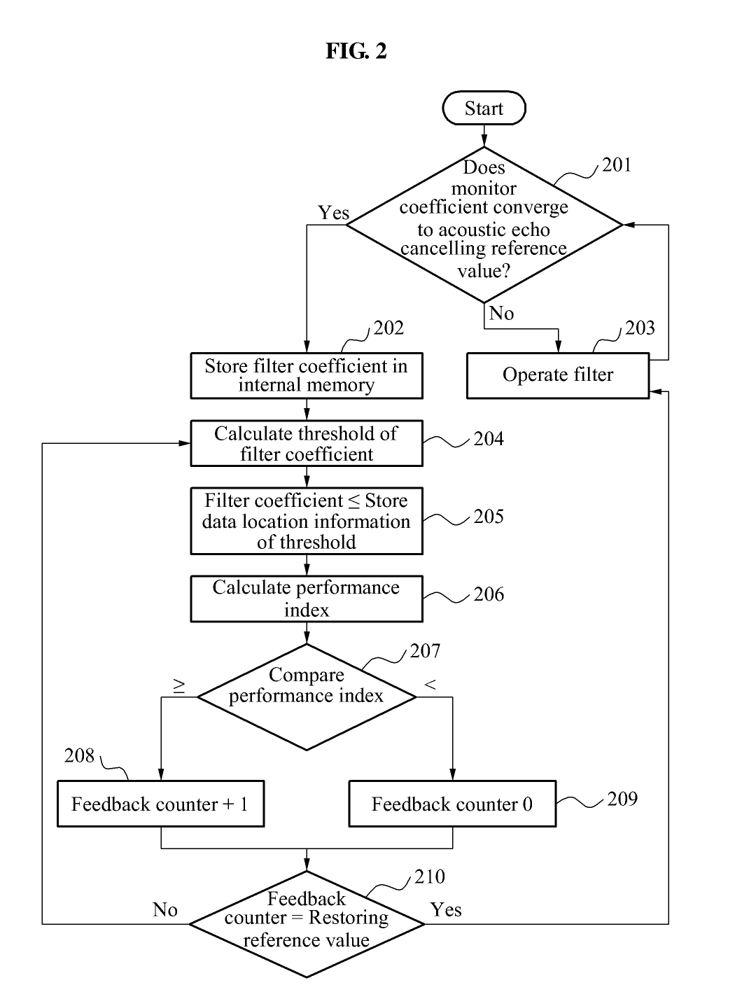

The apparatus for cancelling the wideband acoustic echo may omit performing a filtering operation and a coefficient updating with respect to a location stored in the register, when performing a filtering operation with respect to a subsequent data sample. Hereinafter, an apparatus for cancelling a wideband acoustic echo will be described with reference to FIG. 2.

FIG. 2 is a flowchart illustrating a method for cancelling a wideband acoustic echo according to an embodiment of the present invention.

Referring to FIG. 2, in operation 201, the apparatus for cancelling the wideband acoustic echo may determine whether a monitor coefficient value obtained by dividing an NET energy value by an ERROR energy value converges to an acoustic echo cancelling reference value.

In operation 202, the apparatus for cancelling the wideband acoustic echo may store a coefficient value of a filter in an internal memory when the monitor coefficient value converges to the acoustic echo cancelling reference value.

In operation 203, the apparatus for cancelling the wideband acoustic echo may restore the coefficient value of the filter by operating a filter when the monitor coefficient value fails to converge to the acoustic echo cancelling reference value.

In operation 204, the apparatus for cancelling the wideband acoustic echo may calculate a threshold value of the coefficient value of the filter.

In operation 205, the apparatus for cancelling the wideband acoustic echo may store data location information in a register when the coefficient value of the filter is less than or equal to the threshold value.

When an updating of the coefficient value of the filter is completed, the apparatus for cancelling the wideband acoustic echo may store corresponding location information in the register by determining a resulting value of the comparing each of the coefficient value of the filter and the threshold value to be insignificant data when the resulting value is less than or equal to the threshold value.

The apparatus for cancelling the wideband acoustic echo may not perform a filtering operation and a coefficient updating with respect to location information stored in the register, in performing an NLMS filtering operation with respect to a subsequent sample.

In operation 206, the apparatus for cancelling the wideband acoustic echo may calculate a performance index.

In operation 207, the apparatus for cancelling the wideband acoustic echo may compare the performance index and a predetermined convergence index.

The apparatus for cancelling the wideband acoustic echo may calculate the performance index, and compare a resulting value of the calculation and an index value of a convergence state upon completion of the filtering operation.

In operation 208, the apparatus for cancelling the wideband acoustic echo may increase a feedback counter value when the performance index is less than or equal to the predetermined convergence index.

In operation 209, the apparatus for cancelling the wideband acoustic echo may set the feedback counter value to “0” when the performance index is greater than the predetermined convergence index.

In operation 210, the apparatus for cancelling the wideband acoustic echo may restore the feedback counter value to the coefficient value of the filter when the feedback counter value corresponds to a predetermined restoring value.

For example, the apparatus for cancelling the wideband acoustic echo may increase the feedback counter value by 1 when a new result of is lower than an acceptable tolerance for the performance index value, and restore the feedback counter value to an NLMS coefficient value that is stored when the feedback counter value is greater than “40”.

The apparatus for cancelling the wideband acoustic echo may detect a double-talk with respect to noise of data, using a detecting unit (not shown).

The double-talk may refer to an instance in which a Far-End Talker (FET) signal and an NET signal exist simultaneously.

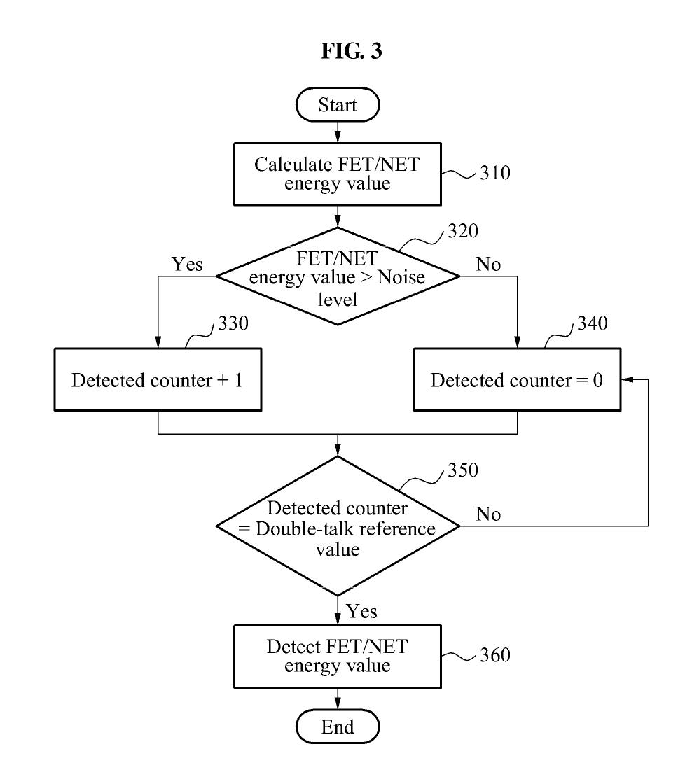

Hereinafter, a method for detecting a double-talk according to an aspect of the present invention will be described with reference to FIG. 3.

FIG. 3 is a flowchart illustrating a method for detecting a double-talk according to an embodiment of the present invention.

Referring to FIG. 3, in operation 310 a detecting unit according to an embodiment of the present invention may calculate an FET energy value and an NET energy value with respect to the data.

An energy calculating unit according to an aspect of the present invention may calculate the FET energy value based on Equation 1:

L_{—}fe(n+1)=L_{—}fe(n)−2̂(−10)*L_{—}fe(n)+scaling_factor*FET [Equation 1]

where L_fe(n+1) may denote a subsequent FET energy value, L_fe(n) may denote a current FET energy value, and scaling_factor*FET may denote a scaling factor of the FET energy value.

The energy calculating unit may calculate the NET energy value based on Equation 2:

L_{—}ne(n+1)=L_{—}ne(n)−2̂(−10)*L_{—}ne(n)+scaling_factor*FET [Equation 1]

where L_ne(n+1) may denote a subsequent NET energy value, L_ne(n) may denote a current NET energy value, and scaling_factor*NET may denote a scaling factor of the NET energy value.

In operation 320, a detecting unit may compare the FET energy value and the NET energy value to a noise energy level, using an energy comparing unit.

In operation 330, the detecting unit may increase a detected counter value when the FET energy value and the NET energy value are determined to be higher than the noise energy level, using a detecting counter.

In operation 340, the detecting unit may initialize the detected counter value to “00” when the FET energy value and the NET energy value are determined to be lower than the noise energy level, using the detecting counter.

The apparatus for cancelling the wideband acoustic echo may reflect previous values in a current energy value, and perform a function of desensitizing an instantaneous energy rise.

The apparatus for cancelling the wideband acoustic echo may increase the detected counter value by +1, when an energy value embodied through such a function is determined to be higher than the noise energy level.

In operation 360, the apparatus for cancelling the wideband acoustic echo may determine that a double-talk with respect to the noise of data is detected when the detected counter value corresponds to a predetermined double-talk reference value, using a determining unit in operation 350.

For example, the apparatus for cancelling the wideband acoustic echo may determine that a signal is detected when the detected counter value is greater than “20”.

According to an aspect of the present invention, there is provided an apparatus for cancelling a wideband acoustic echo that may calculate a threshold value of a coefficient value of an adaptive filter, when the coefficient value is less than or equal to the threshold value, may not perform a filtering operation with respect to a corresponding coefficient value, and may reduce power consumption by skipping an updating operation of the corresponding coefficient value without performing the filtering operation with respect to the corresponding coefficient value.

According to an embodiment of the present invention, there is provided an apparatus for cancelling a wideband acoustic echo that may store a coefficient value of an adaptive filter by monitoring a monitor coefficient value being a performance index when the monitor coefficient value is at maximum, and restore a system performance promptly, by replacing an NLMS coefficient value of a filter with a memory value when a resulting value of the monitoring falls below a specific threshold value.

According to an embodiment of the present invention, there is provided an apparatus for cancelling a wideband acoustic echo that may improve an adaptability of a coefficient value of an adaptive filter by decreasing a misidentification of double-talk due to noise.

According to an embodiment of the present invention, there is provided a configuration for minimizing power consumption of an NMLS apparatus, and for restoring a system rapidly.

According to an embodiment of the present invention, there is provided a method for detecting a double-talk that prevents a malfunction due to noise, and the like, of an FET signal or an NET signal.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for cancelling a wideband acoustic echo, the apparatus comprising:
a determining unit to determine whether a monitor coefficient value obtained by dividing a Near-End Talker (NET) energy value by an ERROR energy value converges to an acoustic echo cancelling reference value;
an internal memory to store a coefficient value of a filter when the monitor coefficient value converges to the acoustic echo cancelling reference value;
a calculating unit to calculate a threshold value of the coefficient value of the filter and a performance index;
a register to store data location information when the coefficient value of the filter is less than or equal to the threshold value;
an index counter to increase a feedback counter value when the performance index is determined to be lower than a predetermined convergence index based on a result of the comparing the performance index and the predetermined convergence index, using the determining unit; and
a restoring unit to restore the feedback counter value to the coefficient value of the filter when the feedback counter value corresponds to a predetermined restoring reference value.

2. The apparatus of claim 1, wherein the filter applies a Normalized Least Mean Square (NLMS) adaptive filter.

3. The apparatus of claim 1, wherein when a filtering operation with respect to a subsequent data sample is performed, performing a filtering and a coefficient updating with respect to a location stored in the register is omitted.

4. The apparatus of claim 1, further comprising:
a detecting unit to detect an occurrence of a double-talk with respect to noise of data.

5. The apparatus of claim 4, wherein the detecting unit comprises:
an energy calculating unit to calculate a Far-End Talker (FET) energy value and an NET energy value with respect to the data.

6. The apparatus of claim 5, wherein the energy calculating unit calculates the FET energy value based on Equation 1:
L_{—}fe(n+1)=L_{—}fe(n)−2̂(−10)*L_{—}fe(n)+scaling_factor*FET [Equation 1]
where L_fe(n+1) denotes a subsequent FET energy value, L_fe(n) denotes a current FET energy value, and scaling_factor*FET denotes a scaling factor of the FET energy value.

7. The apparatus of claim 5, wherein the energy calculating unit calculates the NET energy value based on Equation 2:
L_{—}ne(n+1)=L_{—}ne(n)−2̂(−10)*L_{—}ne(n)+scaling_factor*FET [Equation 1]
where L_ne(n+1) denotes a subsequent NET energy value, L_ne(n) denotes a current NET energy value, and scaling_factor*NET denotes a scaling factor of the NET energy value.

8. The apparatus of claim 5, wherein the detecting unit further comprises:
an energy comparing unit to compare the FET energy value and the NET energy value to a noise energy level;
a detecting counter to increase a detected counter value when the FET energy value and the NET energy value are determined to be higher than the noise energy level as a result of the comparing; and
a determining unit to determine that an occurrence of a double-talk with respect to the noise of data is detected when the detected counter value corresponds to a predetermined double-talk reference value.

9. A method for cancelling a wideband acoustic echo, the method comprising:
determining whether a monitor coefficient value obtained by dividing a Near-End Talker (NET) energy value by an ERROR energy value converges to an acoustic echo cancelling reference value;
storing a coefficient value of a filter in an internal memory when the monitor coefficient value converges to the acoustic echo cancelling reference value;
calculating a threshold value of the coefficient value of the filter;
storing data location information in a register when the coefficient value of the filter is less than or equal to the threshold value;
calculating a performance index;
comparing the performance index and a predetermined convergence index;
increasing a feedback counter value when the performance index is lower than the predetermined convergence index; and
restoring the feedback counter value to a coefficient value of a filter when the feedback counter value corresponds to a predetermined restoring reference value.

10. The method of claim 9, further comprising:
detecting an occurrence of a double-talk with respect to noise of data.

11. The method of claim 10, wherein the detecting the occurrence of the double-talk comprises:
calculating a Far-End Talker (FET) energy value and an NET energy value with respect to the data.

12. The method of claim 11, wherein detecting of the double-talk further comprises:
comparing the FET energy value and the NET energy value to a noise energy level;
increasing a detected counter value when the FET energy value and the NET energy value are determined to be higher than the noise energy level as a result of the comparing; and
determining that a double-talk with respect to the noise of data is detected when the detected counter value corresponds to a predetermined double-talk reference value.
